(19) United States
(12) Patent Application Publication
(10) Pub. No.: US 2004/0257629 A1
(43) Pub. Date: Dec. 23, 2004

(54) Lithograph comprising a moving cylindrical lens system

(76) Inventors: Steffen Noehte, Weinheim (DE); Christoph Dietrich, Heidelberg (DE); Robert Thomann, Heidelberg (DE); Stefan Stadler, Hamburg (DE); Joern Leiber, Hamburg (DE)

Correspondence Address: PROSKAUER ROSE LLP, PATENT DEPARTMENT, 1585 BROADWAY, NEW YORK, NY, 10036-8299, US

(21) Appl. No.: 10/485,009

(22) PCT Filed: Jul. 26, 2002
(86) PCT No.: PCT/EP02/08372

(30) Foreign Application Priority Data
Jul. 27, 2001 (DE) 10136569.1

(51) Int. Cl. G03H 1/08

(52) U.S. Cl. 359/35; 430/1; 430/2; 359/9

(57) ABSTRACT

The invention relates a lithograph for producing computer-generated holograms in a storage medium (13), provided with a source for generating a write beam (2), a moving lens (4) for focussing the write beam (2), means for displacing the moving lens (4) along a direction of movement (6), and with a means for displacing the write beam (2) in relation to the storage medium (13) in a manner that is perpendicular to the direction of movement (6). The aim of the invention is to provide a lithograph in which disruptions in the movement of a lens perpendicular to the direction of movement thereof do not effect this end, the moving lens (4) has refractive power only essentially in a first direction that is parallel to the direction of movement (6). In addition, a stationary lens (9) is provided, and this stationary lens (9) has refractive power only essentially in a second direction (5), whereby the second direction (5) is perpendicular to the first direction and to the write beam (2).

The present invention relates to a lithograph for producing optical structures in a storage medium. In particular, the lithograph has a source for generating a write beam, a moving lens for focusing the write beam onto the storage medium, means for moving the moving lens in a direction of movement perpendicular to the write beam, and a means for displacing the write beam relative to the storage medium perpendicular to the direction of movement.

The optical structures to be generated are preferably computer-generated holograms. However, it is also possible for microimages and micro-barcodes, that is to say directly readable information, to be written as optical structures into the storage medium. Thus, when the production of computer-generated holograms is spoken of below, this does not constitute a limitation of the invention to this preferred application.

Computer-generated holograms are two-dimensional holograms that consist of individual points having different optical properties, and from which images and/or data are reproduced upon illumination by a coherent electromagnetic wave, in particular a light wave, through diffraction in transmission or reflection. The different optical properties of the individual points can be reflection properties, for example owing to surface topography, varying optical path lengths in the material of the storage medium (refractive indices), different transmission properties or color values of the material.

The optical properties of the individual points are calculated by a computer, and so a so-called computer-generated hologram (CGH) is involved here. With the aid of the focused write beam, the individual points of the hologram are written into the material during the writing of the hologram, the focus lying in the region of the surface or in the material of the storage medium. Focusing effects in the region of the focus a small area of action on the material of the storage medium, and so a multiplicity of points of the hologram can be written on a small area. The optical property of the respectively written point is a function in this case of the intensity of the write beam. For this purpose, the write beam is scanned in two dimensions with varying intensity over the surface of the storage medium. The modulation of the intensity of the write beam is performed in this case either via an internal modulation of the light source, for example a laser diode, or via an external modulation of a write beam outside the light source, for example with the aid of optoelectronic elements. Furthermore, the light source can be designed as a pulsed laser whose pulse lengths can be controlled such that the intensity of the write beam can be controlled via the pulse lengths.

The scanning of the intensity-modulated write beam thus produces an area with an irregular point distribution, the computer-generated hologram. This can be used to identify and individualize any desired objects.

Scanning lithographic systems per se are widespread. For example, scanning optical systems are incorporated in conventional laser printers. However, these systems cannot be used for the production of holograms, since the requirements for this intended application differ considerably from those in laser printers. In the case of good printing systems, the resolution is around 2500 dpi while, in the production of holograms, a resolution of about 25 000 dpi is required. In addition, in computer-generated holography, only comparatively small areas are written. These are, for example, 1 to 5 mm², other sizes also being possible. The accuracy of the write pattern in the case of a lithograph for the production of computer-generated holograms of, for example, 1000×1000 points on an area of 1×1 mm² must be about ±0.1 μm in both orthogonal directions. Furthermore, the writing speed should be about 1 Mpixel/s, in order that in each case a hologram can be written in a time of about 1 s. The aforementioned magnitudes are exemplary and do not constitute any limitation of the invention.

Computer-generated holograms can be produced by means of conventional scanning methods, in which the angle of the incident beam is varied by stationary optics. For example, scanning mirror lithographs with galvanometer and polygonal scanners operate on this principle. However, scanners of this type have the disadvantage that the implementation of this principle entails a great deal of optical and mechanical effort. This fact places tight limits on the maximization of the speed and the resolution of optical lithographs, since, for this purpose, objectives are needed which permit a large field angle and convert the deflection angle, preferably linearly, into an x deflection in the focal plane of the objective (“F-theta” objectives) Moreover, the objectives used have to be corrected with regard to the image curvature (“flat field” objectives), so that complicated multi-part optics have to be used which are an obstacle to a compact configuration of the lithograph. Furthermore, complex optics of this type place great demands on the mechanics of the lithograph, since the latter have to move a relatively large mass. This also results from the fact that it is not possible to select arbitrarily small scanning mirrors, since the aperture of the optical system still continues to determine the resolution.

However, scanning optical systems are also known in which the scanning movement is not achieved via a moving beam but via moving optics. However, the accuracy of the positioning of the write beam which permits a prescribed point pattern of the computer-generated hologram to be maintained for the writing speeds to be achieved are not achieved here either. A high guiding accuracy of the lens is required if a lens is moved linearly perpendicular to the write beam in order to generate a movement of the focused write beam on the storage medium. This means that the deviations perpendicular to the prescribed track, termed “wobbles”, must be smaller than 0.1 μm so that a sufficient accuracy of the write pattern is achieved. Linear guidance with such a guiding accuracy can be produced only with substantial outlay. Moreover, in mechanical systems disturbances occur in the form of shocks and vibrations, and these can likewise reach the order of magnitude of 0.1 μm.

The invention is therefore based on the technical problem of providing a lithograph in accordance with the preamble of claim 1 in the case of which disturbances in the movement of a lens perpendicular to the direction of movement thereof have no influence on the quality of the written hologram.

The technical problem indicated above is solved by a lithograph having the features of claim 1 by virtue of the fact that the moving lens has refractive power only essentially parallel to the direction of movement, and that a second stationary lens is provided which has refractive power only essentially in a second direction, the second direction being perpendicular to the direction of movement and to the write beam.

In a lithograph according to the invention, the write beam is focused by the cooperation of two lenses. Because the lenses have refractive power only essentially in one direction, the incident write beam is focused only to a line by one of the two lenses. Since the directions in which the lenses have refractive power are perpendicular to one another, the write beam is focused into a focal point upon passing through the two lenses.

The line onto which the stationary lens focuses the write beam defines the track along which the individual points of the hologram are written. By displacing the moving lens, the focal point on the track is shifted, and the locations on the track at which the points are to be written are thereby fixed. Because of the slower movement, the stationary lens can be guided with the aid of a heavier guide, the result being a more stable and more accurate line guidance.

Disturbances to the movement of the moving lens perpendicular to its direction of movement have no influence on the position of the focal point, because of the low or missing refractive power of the lens in this direction. The hologram can therefore also then be written line by line into the storage medium with high accuracy when such disturbances occur. Consequently, a linear guidance with an accuracy much worse than 0.1 μm can be used for the moving lens. It is possible thereby, in particular, to reduce the outlay on production and the costs associated therewith.

The individual lines can be approached by displacing the write beam relative to the storage medium perpendicular to the direction of movement of the moving lens, the result being to achieve scanning of the storage medium.

The invention is explained in more detail below with the aid of preferred exemplary embodiments.

In a preferred way, the lenses are designed as two cylindrical lenses that are preferably arranged perpendicular to one another. Consequently, the lenses have refractive power only essentially in one direction, and these directions are perpendicular to one another.

The moving and the stationary lenses are preferably arranged in such a way that the focal planes of the two lenses coincide with the plane in which the computer-generated hologram is to be written. This ensures that the focal point at which the write beam is focused during passage through the two lenses always lies in the plane of the hologram.

The means for detecting the position of the moving lens serve the purpose of permitting specific points to be approached along the track determined by the stationary lens.

Displacing the storage medium perpendicular to the direction of movement of the moving lens permits the storage medium to be written line by line. If further means for detecting the position are provided, it is also possible here for specific lines to be approached in a controlled fashion.

As an alternative to displacing the storage medium, it is also possible to displace the stationary lens perpendicular to the direction of movement of the moving lens and parallel to the direction in which the stationary lens essentially has refractive power, in order to permit the storage medium to be written line by line.

With the aid of a collimator lens that is arranged between the source for generating the write beam and the moving lens, the write beam can be collimated onto the two lenses up to a prescribed beam cross section.

The use of a laser diode as source for generating the write beam permits the internal modulation of the source, and there is no need for any further optically active elements for modulation purposes.

The connection of the means for detecting the position of the storage medium and the moving lens to an arithmetic unit, and the connection of the arithmetic unit to the laser diode permit optical structures and, in particular, computer-generated holograms to be written into the storage medium.

The invention is described below only by way of example with the aid of the drawing, in which:

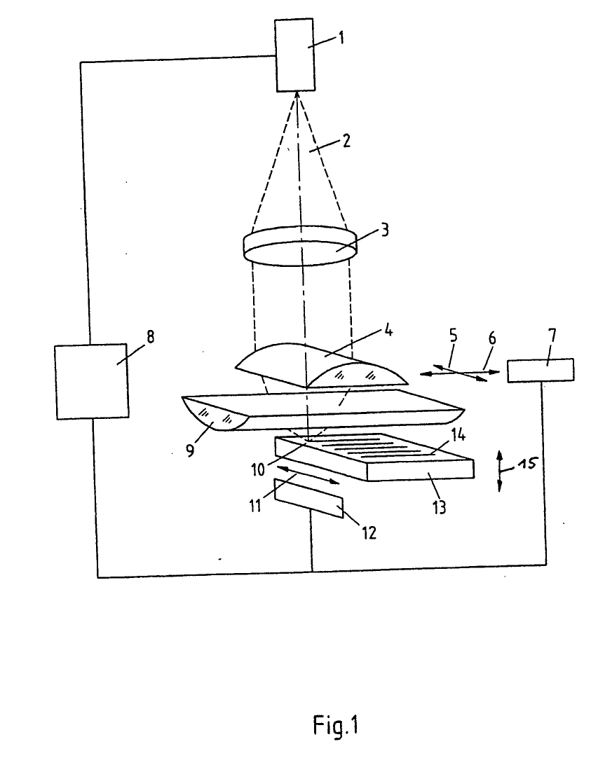

FIG. 1 shows an exemplary embodiment of a lithograph according to the invention, in a side view.

FIG. 1 shows an exemplary embodiment of a lithograph according to the invention, as a side view in a partially perspective representation. A laser diode 1 is arranged in the upper part as source for generating a write beam 2. Fitted below the laser diode 1 is a collimator lens 3 and below the latter, in turn, a moving lens 4, preferably designed as a cylindrical lens. The moving lens 4 extends along the direction 5, the focal plane of the moving lens 4 being perpendicular to the write beam 2. The moving lens 4 can be moved perpendicular to the write beam 2 along the direction of movement 6, means (not illustrated here) for moving the moving lens 4 being provided. The moving lens 4 has refractive power only essentially in one direction, which is essentially parallel to the direction of movement 6 of the moving lens 4. A unit 7 detects the position of the moving lens 4 in the direction of movement 6, and is connected to an arithmetic unit 8.

A stationary lens 9, likewise preferably designed as a cylindrical lens, is arranged below the moving lens 4. The stationary lens 9 has refractive power essentially only in a second direction 5 that is perpendicular to the direction of movement 6 and the write beam 2. Consequently, the directions in which the lenses essentially have their refractive power are perpendicular to one another in a plane perpendicular to the write beam. The stationary lens 9 designed as a cylindrical lens extends perpendicular to the second direction 5. The refractive power of the moving lens 4 and of the stationary lens 9 is selected in this case in such a way that the common focal point 10 of the lenses lies in the plane in which the storage medium 13 is arranged or in which the points of the computer-generated hologram are to be written into the storage medium 13.

The storage medium 13 is provided such that it can be moved along the direction 11, means (not illustrated) being provided for moving the storage medium 13 along this direction 11. Furthermore, a unit 12 is provided for detecting the position of the storage medium 13 along the direction 11. The unit 12 is connected to the arithmetic unit 8. Furthermore, the arithmetic unit 8 is connected to the laser diode 1.

When producing a computer-generated hologram in the storage medium 13, the write beam 2 generated by the laser diode 1 is firstly collimated by the collimator lens 3 onto a prescribed beam cross section and directed onto the moving lens 4 and the stationary lens 9. The stationary lens 9 focuses the incident collimated write beam 2 onto a line which runs essentially parallel to the direction of movement 6. This line defines the track of the hologram line 14 to be written. The moving lens 4 focuses the write beam 2 likewise onto a line that runs perpendicular to the first line such that the write beam 2 is focused at a focal point 10, which lies in the plane of the storage medium 13, in the common focal plane of the lenses 4 and 9. This focal point 10 can be displaced by moving the moving lens 4 along the direction of movement 6, and the optical properties of the material can be changed by the interaction of the write beam 2 with the material of the storage medium 13 in the region of the focal point 10 when the intensity of the write beam 2 is sufficiently high there.

The storage medium 13 can be written in planar fashion by displacing the storage medium 13 along the direction 11 such that the individual hologram lines 14 can be written in the way represented above.

During the movement of the moving lens 4, the respective position of the moving lens, and thus that of the focal point 10, are transmitted by the units 7 and 12 to the arithmetic unit 8 which processes the information, thus obtained, with the hologram to be written, and generates the driving of the laser 1 therefrom.

As is further illustrated in FIG. 1 by the double arrow 15, the storage medium 13 can be moved essentially parallel to the direction of propagation of the write beam 2 relative to the lenses 4 and 9. This renders it possible for the computer-generated holographic information to be written in at different depths of the material of the storage medium 13.

1. A lithograph for producing optical structures, in a storage medium, in particular computer-generated holograms,
having a source for generating a write beam,
having a moving lens for focusing the write beam onto the storage medium,
having a means for moving the moving lens in a direction of movement perpendicular to the write beam, and
having a means for displacing the write beam relative to the storage medium perpendicular to the direction of movement, wherein
the moving lens has refractive power only essentially parallel to the direction of movement,
a stationary lens is provided, and
the stationary lens has refractive power only essentially in a second direction,
the second direction being perpendicular to the direction of movement and the write beam.

2. The lithograph as claimed in claim 1, wherein the moving lens and the stationary lens are designed as cylindrical lenses.

3. The lithograph as claimed in claim 2, wherein the moving lens extends perpendicular to the first direction, and in that the stationary lens extends perpendicular to the second direction.

4. The lithograph as claimed in claim 1 wherein the focal planes of the moving lens and the stationary lens essentially coincide with the plane in which the computer-generated hologram is arranged in the storage medium.

5. The lithograph as claimed in claim 1, wherein a means is provided for detecting the position of the moving lens in the direction of movement.

6. The lithograph as claimed in claim 1, wherein a means for displacing the storage medium is provided as means for displacing the write beam perpendicular to the direction of movement.

7. The lithograph as claimed in claim 6, wherein a means is provided for detecting a displacement position of the storage medium.

8. The lithograph as claimed in claim 1 wherein a means for displacing the stationary lens is provided as means for displacing the write beam perpendicular to the direction of movement.

9. The lithograph as claimed in claim 1, wherein a collimator lens is arranged between the source for producing the write beam and the moving lens.

10. The lithograph as claimed in claim 1, wherein a laser diode is provided as source for producing the write beam.

11. The lithograph as claimed in claim 1, wherein an arithmetic unit is provided, the arithmetic unit being connected to the laser diode, the means for detecting the position of the moving lens, and the means for detecting the displacement position of the storage medium.

12. The lithograph as claimed in claim 1, wherein the storage medium can be moved essentially parallel to the direction of propagation of the write beam relative to the lenses.
